(19) United States
(12) Patent Application Publication
(10) Pub. No.: US 2007/0145892 A1
(43) Pub. Date: Jun. 28, 2007

(54) Electro-luminescent display panel and electronic device using the same

(76) Inventor: Kuang-Jung Chen, Taipei City (TW)

Correspondence Address: LIU & LIU, 444 S. FLOWER STREET, SUITE 1750, LOS ANGELES, CA, 90071, US

(21) Appl. No.: 11/318,779

(22) Filed: Dec. 27, 2005

(51) Int. Cl. H01J 1/62

(52) U.S. Cl. 313/506

(57) ABSTRACT

An electro-luminescent display panel includes a first substrate having an array of light emitting elements corresponding to a plurality of pixels thereon and a second substrate having light transmissive regions and a reflective light enhancing pattern layer facing the light emitting elements in the first substrate, wherein the reflective light enhancing pattern layer directs oblique light emitted from the light emitting elements to the light transmissive regions. In another aspect, a spacer layer defines a predetermined gap between the first and second substrates. The space layer may provide a light enhancing structure.

### BACKGROUND OF THE INVENTION

1. Field of the Invention

The present invention generally relates to an electro-luminescent (EL) display panel and an electronic device using the same. More particularly, the present invention relates to a top emission electro-luminescent display panel and an electronic device using the same.

2. Description of Related Art

Electro-luminescent displays are devices with elements that emit light (e.g., an organic light emitting diode (OLED) display, a plasma display, etc.). The properties of the electro-luminescent display include low driving voltage, high brightness, high efficiency and high contrast. Therefore, the electro-luminescent display is highly expected to be the next generation of flat panel display and development is desired.

Generally, electro-luminescent displays are divided into top emission electro-luminescent displays and bottom emission electro-luminescent displays. For example, for a top emission OLED display, full-color displaying can be achieved by white light emitting diodes co-located with a color filter layer or blue light emitting diodes co-located with a color changing medium. Usually, a black matrix is formed corresponding to the color filter layer or the color changing medium to increase displaying contrast. However, the display will lose the light emitting efficiency such as brightness and contrast due to the light emitting from the white or blue light emitting diodes passes in all directions.

### SUMMARY OF THE INVENTION

The invention is directed to the broad concept of providing a reflective structure in an EL display panel to enhance light emitting efficiency in the desired direction. In one aspect of the present invention, a reflective light enhancing pattern layer is provided between the light transmissive regions of one substrate and the layer of light emitting elements on another substrate of an electro-luminescent display device. More particularly, the EL display panel comprises a first substrate comprising an array of light emitting elements (e.g., OLEDs) corresponding to a plurality of pixels thereon, and a second substrate comprising light transmissive regions and a reflective light enhancing pattern layer facing the light emitting elements in the first substrate, wherein the reflective light enhancing pattern layer directs oblique light emitted from the light emitting elements to the light transmissive regions.

In one embodiment, the light enhancing pattern layer comprises reflective surfaces (such as reflective prisms or faceted reflective blocks) that are angled to reflect oblique light emitted from the light emitting elements towards the light transmissive regions in the first substrate.

In another aspect, the present invention discloses an electro-luminescent display panel comprising a first substrate, a second substrate and an reflective light enhancing pattern layer between the first and second substrates. The first substrate comprises a plurality light emitting elements (e.g., electroluminescent elements) thereon. The second substrate comprises a black matrix thereon. The reflective light enhancing pattern layer is located corresponding to the black matrix and it may regard to as moisture-absorbing material since it constituted an active metal.

Moreover, in another aspect, the present invention discloses a reflective light enhancing pattern layer of the electro-luminescent display panel which serves as a spacer or supporter to maintain a predetermined gap between the two substrates of the display panel.

It is to be understood that both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view showing an electro-luminescent display panel according to an embodiment of the present invention.

FIG. 2 is a cross-section view along I-I′ of FIG. 1.

FIG. 3A is a circuit diagram of the electro-luminescent display panel according to an embodiment of the present invention.

FIG. 3B shows a circuit diagram of one pixel of the electro-luminescent display panel in FIG. 3A.

FIGS. 4A˜4B are cross-section views showing a method of forming a reflective light enhancing pattern layer on the second substrate according to an embodiment of the present invention.

FIGS. 5A˜5B are cross-section views showing another method of forming a reflective light enhancing pattern layer on the second substrate according to an embodiment of the present invention.

FIG. 6 is a cross-section view showing an organic electro-luminescent display panel according to another embodiment of the present invention.

FIG. 7 is a cross-section view showing the structure in the region 500 of FIG. 6 according to another embodiment of the present invention.

FIG. 8 is a cross-section view showing an organic electro-luminescent display panel according to another embodiment of the present invention.

FIG. 9 is a drawing showing an electronic device according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

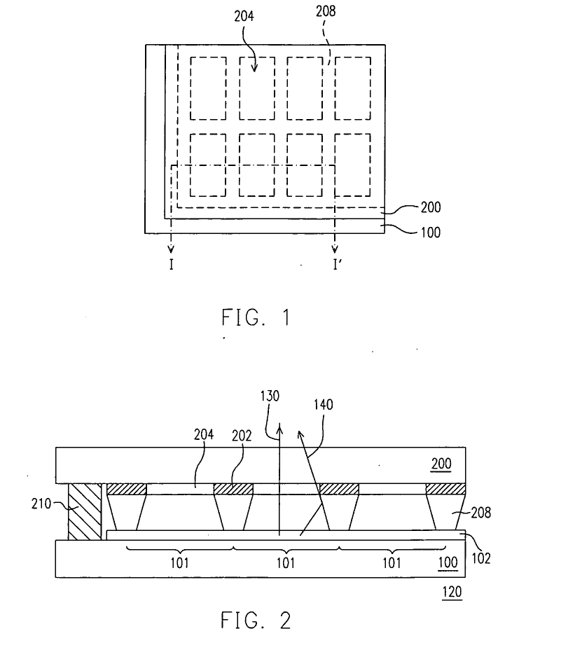

As shown in FIG. 1 and FIG. 2, the electro-luminescent display panel 120 comprises a first substrate 100 comprising an array of light emitting elements 102, such as organic light emitting diodes or inorganic light emitting diodes, corresponding to a plurality of pixels 101 thereon, and a second substrate 200 comprising light transmissive regions 204 and a reflective light enhancing pattern layer 208 extending towards the array of light emitting elements 102 in the first substrate 100, wherein the reflective light enhancing pattern layer 208 directs oblique light emitted from the light emitting elements 102 to the light transmissive regions 204. In an embodiment, the reflective light enhancing pattern layer 208 comprises sections having a trapezoidal cross-section, and reflective side surfaces that are angled to reflect oblique light emitted from the light emitting elements 102 towards the light transmissive regions 204 in the second substrate 200. The reflective surface may have a mirror finish or a reflective matte finish to be diffusively reflective. The reflective light enhancing pattern layer 208 comprises reflective prisms or faceted reflective blocks, for example. In the schematic representation of FIG. 2. For simplicity, the array of the light emitting elements 102 is shown as a continuous layer in FIG. 2. The light enhancing pattern layer 208 may extend to contact the first substrate 100, with the each light emitting elements 102 located within the pixel 101, between adjacent prism or blocks of the reflective light enhancing pattern layer 208.

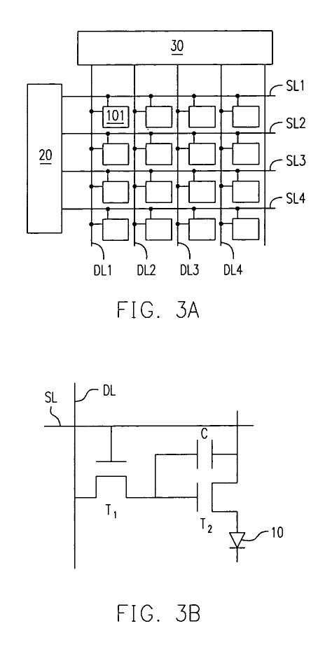

In an embodiment, the circuit diagram of the electro-luminescent display panel according to an embodiment of the present invention is as shown in FIG. 3A, and the circuit diagram of one pixel of the electro-luminescent display panel is as shown in FIG. 3B. As shown in FIG. 3A and FIG. 3B, the display panel comprises a plurality of scan lines such as SL1 to SL4, a plurality of data lines such as DL1 to DL4 and a plurality of pixels 101 thereon, wherein the scan lines SL1 to SL4 are electrically connected to a first driving integrated circuit (IC) 20 while the data lines DL1 to DL4 are electrically connected to a second driving IC 30. The circuit diagram of one of the pixels 101 is as shown in FIG. 3B, the pixel 101 electrically connected to the scan line SL1 and the data line DL1 comprises a switching thin film transistor T1, a driving thin film transistor T2, a capacitor C and a light emitting diode 10. The scan line SL is electrically connected to the gate of the switching thin film transistor T1, and the data line DL is electrically connected to the source of the switching thin film transistor T1. One terminal of the capacitor C is electrically connected to the drain of the switching thin film transistor T1 and the gate of the driving thin film transistor T2, and the other terminal of the capacitor C is electrically connected to the source of the driving thin film transistor T2. The light emitting diode 10 is electrically connected to the drain of the driving thin film transistor T2.

According to an embodiment of the present invention, as shown in FIG. 1 and FIG. 2, the second substrate 200 further comprises a black matrix 202 disposed under the reflective light enhancing pattern layer 208. In addition, the light transmissive regions 204 further comprise a color filter layer (CF) or a color changing medium (CCM) therein (not shown). In an embodiment, the light emitting elements 102 are white light emitting units, and the light transmissive regions 204 include a color filter (CF) layer comprising red, green and blue light filter resins therein. In another embodiment, the light emitting elements 102 are blue organic light emitting units, and the light transmissive regions 204 includes a color changing medium (CCM) therein. According, the reflective light enhancing pattern layer 208 is located corresponding to the black matrix 202. It is contemplated that the reflective light enhancing pattern layer 208 and the black matrix 202 may be combined in an integral structure, well within the scope and spirit of the present invention. The black matrix may include the structure of the reflective light enhancing pattern, with reflective side surfaces.

In the embodiment, the reflective light enhancing pattern layer 208 is disposed on the black matrix 202 of the second substrate 200, as shown in FIG. 2. The reflective light enhancing pattern layer 208 is, for example, selected from the group consisting of a metal, a polymer material having reflective property and a combination thereof. For example, the reflective light enhancing pattern layer 208 comprises aluminum (Al), chromium (Cr) or molybdenum (Mo).

In the embodiment of FIG. 2, light 130 emitted from the light emitting element 102 of each pixel 101 passes through the light transmissive region 204 and then emits out of the display panel 120. Especially, light 140 emitting from the light emitting element 102 is reflected by the reflective light enhancing pattern layer 208 and then through the light transmissive region 204. In conventional electro-luminescent display panels, if light emitted into the black matrix, it is absorbed by the black matrix and can not be a part of the light emitting out of the display panel. Therefore, comparing with the conventional electro-luminescent display panels, the display panel 120 of the present invention has better brightness and displaying quality.

In addition, the reflective light enhancing pattern layer 208 can also serve as a spacer or supporter in the display panel 120. In details, the first substrate 100 and the second substrate 200 are sealed with a sealant 210, and an inner gas or liquid is filled in the gap between the two substrates 100, 200 and the sealant 210. The sealant 210 usually has a height of 5˜50 μm, for example. For example, if the height for the sealant 210 is 10 μm, the total height of the films, such as the light emitting element layer 102, on the first substrate 100, the films, such as the black matrix layer 202, on the second substrate 200 and the reflective light enhancing pattern layer 208 is equal to 10 μm. Therefore, the reflective light enhancing pattern layer 208 can also serve as a spacer or supporter to maintain a predetermined gap between the two substrates.

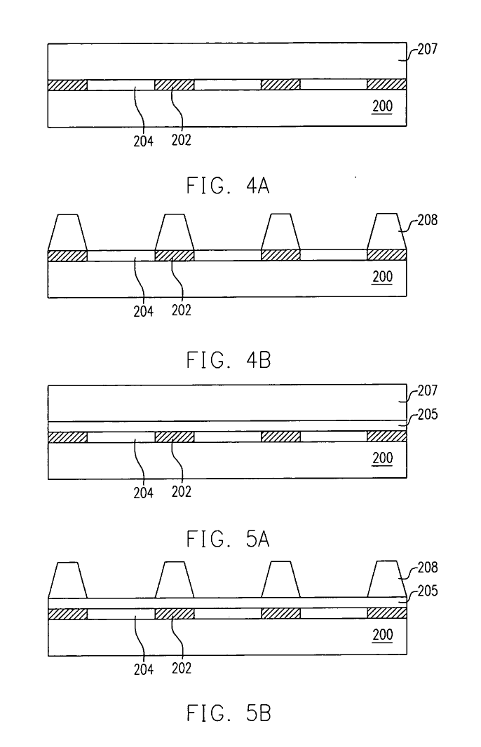

The reflective light enhancing pattern layer 208 may be fabricated by the method of FIG. 4A˜FIG. 4B. As shown in FIG. 4A, a substrate 200 having a black matrix 202 and light transmissive regions 204 thereon is provided. Next, a reflective material 207 is formed over the black matrix 202 and the light transmissive regions 204. The reflective material 207 is formed by physical vapor deposition (PVD), such as sputtering process. Thereafter, the reflective material 207 is patterned to form a reflective light enhancing pattern layer 208, as shown in FIG. 4B. The reflective material 207 is patterned by photolithography process and etching process, for example.

The reflective light enhancing pattern layer 208 may also be fabricated by the method of FIG. 5A˜FIG. 5B. As shown in FIG. 5A, a substrate 200 having a black matrix 202 and light transmissive regions 204 is provided. Next, a planarizing layer 205 is formed over the black matrix 202 and the light transmissive regions 204. The planarizing layer 205 is a polymer layer, for example, and has a good adhesion with a reflective material sequentially formed thereon. Next, a reflective material 207 is formed over the planarizing layer 205. Thereafter, the reflective material 207 is patterned to form a reflective light enhancing pattern layer 208, as shown in FIG. 5B.

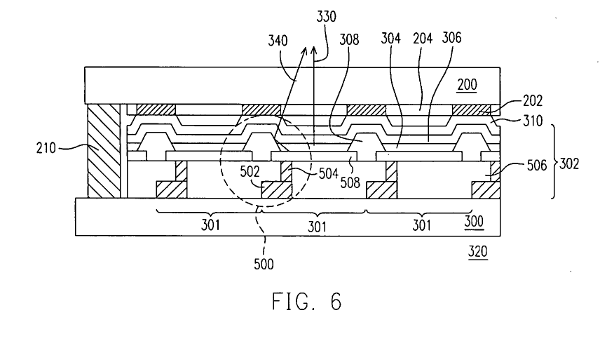

In the embodiment of FIG. 2, the reflective light enhancing pattern layer 208 is formed on the second substrate 200. However, the reflective light enhancing pattern layer may also be formed on the first substrate according to another embodiment of the present invention. As shown in FIG. 6, the electro-luminescent display panel 320 comprises a first substrate 300 having an array of light emitting elements 302 corresponding to a plurality of pixels 301 thereon, a second substrate 200 and a reflective light enhancing pattern layer 308 arranged between the first and second substrates 300, 200. In an embodiment, the light emitting elements 302 on the first substrate 300 comprises an active device 502, an anode layer 508, an organic layer 304 and a cathode layer 306. The active device 502 and the anode layer 508 are isolated through an insulating layer 506, and the active device 502 is electrically connected with the anode 508 via a contact 504. The second substrate 200 includes a black matrix 202 thereon and a color filter layer or a color changing medium as above mentioned is formed in the light transmissive regions 204 of the second substrate 200, for example.

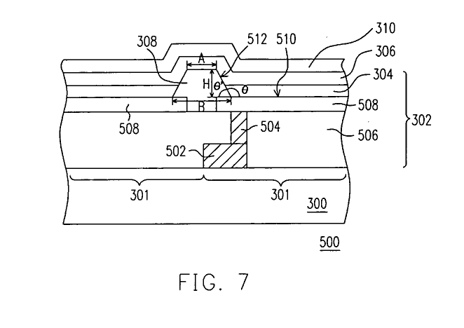

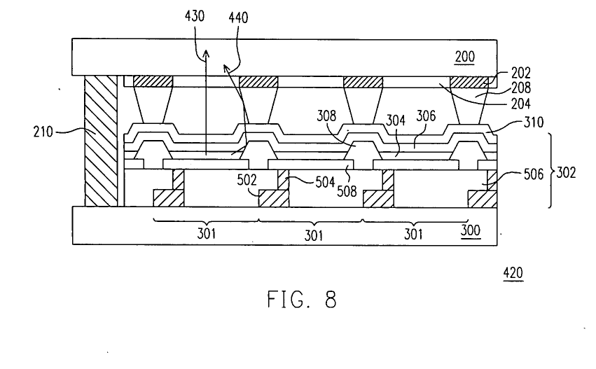

In particular, the reflective light enhancing pattern layer 308 is disposed on the first substrate 300 between the pixels 301. In an embodiment, the reflective light enhancing pattern layer 308 is arranged corresponding to the black matrix 202. The enlarge view of the structure in the region 500 of FIG. 6 is as shown in FIG. 7. Please refer to FIG. 6 and FIG. 7, the reflective light enhancing pattern layer 308 is disposed on the insulating layer 506 and isolates the organic layer 304 and the anode 508 of two adjacent pixels 301. The reflective light enhancing pattern layer 308 has sections having a trapezoidal cross-section. In an embodiment, the top surface 510 of the anode layer 508 and the sidewall 512 of the reflective light enhancing pattern layer 308 has to form a plane having an included angleθfrom 90°˜150°. In other words, the reflective light enhancing pattern layer 308 has a top width A, a bottom width B and a height H, and a relationship of H/2(B−A)=tan θ′ is satisfied, wherein the angle θ′ is from 30°˜90°. The reflective light enhancing pattern layer 308 may be a polymer material having reflective property, for example. The reflective light enhancing pattern layer 308 may also be constituted of an insulating material layer and a reflective material coated on the insulating material layer, for example. The reflective light enhancing pattern layer 308 may also be structured as an integral part of the black matrix, such that the black matrix has reflective side walls. In another embodiment, a passivation layer 310 is further formed covering the cathode layer 306 of the light emitting elements 302.

In the embodiment of FIG. 6, light 330 emitted from the light emitting element 302 of each pixel 301 passes through the light transmissive region 204 and then emits out of the display panel 320. Especially, light 340 emitting from the light emitting element 302 is reflected by the reflective light enhancing pattern layer 308 and then through the light transmissive region 204. Comparing with the conventional organic electro-luminescent display panel, the display panel of the present invention has better light-emitting efficiency because light emits toward the black matrix may be reflected by the reflective light enhancing pattern layer 308 to the light transmissive region 204. In other words, the display panel 320 of the present invention has better brightness and displaying quality.

Similarly, the reflective light enhancing pattern layer 308 can also serve as a spacer or supporter in the display panel 320. In details, the first substrate 300 and the second substrate 200 are sealed with a sealant 210, and an inner gas or liquid is filled in the gap between the two substrates 300, 200 and the sealant 210. The sealant 210 usually has a height of 5˜50 μm for example. For example, if the height for the sealant 210 is 10 μm, the total height of the films, such as the light emitting elements 302 and the passivation layer 310, on the first substrate 300, the films, such as the black matrix layer 202, on the second substrate 200 and the reflective light enhancing pattern layer 308 is equal to 10 μm. Therefore, the reflective light enhancing pattern layer 308 can also serve as a spacer or supporter to maintain the gap between the two substrates in a predetermined level.

According to another embodiment of the present invention, another electro-luminescent display panel is provided. As shown in FIG. 8, the difference between the display panel 420 of FIG. 8 and the display panel 320 of FIG. 6 is that another reflective light enhancing pattern layer 208 is further formed on substrate 200. Preferably, the reflective light enhancing pattern layer 208 is located corresponding to the reflective light enhancing pattern layer 308. In another embodiment, a passivation layer 310 is further formed covering the cathode layer 306 of the light emitting elements 302.

In the embodiment of FIG. 8, light 430 emitted from the light emitting element 302 of each pixel 301 passes through the light transmissive region 204 and then emits out of the display panel 420. Especially, light 440 emitting toward the black matrix 202 is reflected by the reflective light enhancing pattern layer 308 and/or the reflective light enhancing pattern layer 208 and then emits to the light transmissive region 204. Hence, comparing with the conventional organic electro-luminescent display panel, the display panel of the present invention has better light-emitting efficiency because light emits toward the black matrix may be reflected by the reflective light enhancing pattern layers 208, 308 to the light transmissive region 204. In other words, the display panel 420 of the present invention has better brightness and displaying quality.

Similarly, the reflective light enhancing pattern layer 308 and the reflective light enhancing pattern layer 208 can also serve as spacers or supporters in the display panel 420. In details, the first substrate 300 and the second substrate 200 are sealed with a sealant 210, and an inner gas or liquid is filled in the gap between the two substrates 300, 200 and the sealant 210. For example, if the height for the sealant 210 is 10 μm, the total height of the films, such as the light emitting elements 302 and the passivation layer 310, on the first substrate 300, the films, such as the black matrix layer 202, on the second substrate 200, the reflective light enhancing pattern layer 308 and the reflective light enhancing pattern layer 208 is equal to 10 μm. Therefore, the reflective light enhancing pattern layer 308 and the reflective light enhancing pattern layer 208 can also serve as spacers or supporters to maintain the gap between the two substrates in a predetermined level.

While in the foregoing described embodiments, the reflective light enhancing pattern layers are formed on the second substrate, the reflective light enhancing pattern layer may be formed on the first substrate instead (e.g., on the light emitting element layer). Further, the reflective light enhancing pattern layer may be a separate structure not pre-formed on any substrate, but assembled as sandwiched between the first and second substrates.

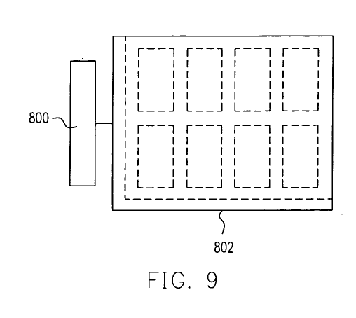

FIG. 9 is a drawing showing an electronic device according to another embodiment of the present invention. The electronic device comprises an electroluminescent display panel 802 and a driving device 800 electrically connected to the organic electro-luminescent display panel 802. The electroluminescent display panel 802 may be the display panel 120 or 320 or 420 (as shown in FIG. 2 or FIG. 6 or FIG. 8). The driving device 800 may comprise a controller (not shown) and an input device (not shown) electrically coupled to the controller, for example. The controller is used to control the display panel 802 to render image in accordance with an input from the input device, and the input device may include a processor or the like to input data to the controller to render an image on the display device 802. Examples of electronic devices include without limitations organic electroluminescent displays and inorganic electroluminescent displays, and electronic devices including such displays, such as a notebook computer, a personal digital assistant (PDA), a digital media player, a digital camera, a portable game console, etc.

Because the electroluminescent display panel of the present invention has the reflective light enhancing pattern layer therein, the electroluminescent display panel has good light-emitting efficiency. As a result, the electroluminescent display panel has advantages of high brightness and good displaying quality.

In addition, the reflective light enhancing pattern layer in the electroluminescent display panel can also serve as a spacer or supporter. Therefore, a predetermined gap between the two substrates of the display panel can be maintained in a predetermined level. In other words, in the electroluminescent display panel of the present invention, the gap between the two substrates is uniform since the reflective light enhancing pattern layer in the electroluminescent display panel serves as a spacer or supporter, such that Newton ring phenomenon does not appear. Moreover, bending of the substrate can also be prevented in the electroluminescent display panel of the present invention because the gap between the two substrates is maintained by the reflective light enhancing pattern layer. As a result, the displaying quality of the electroluminescent display panel can be improved.

It is contemplated for certain display panel designs, it may be desired to not extend the reflective light enhancing pattern layer across the gap between the substrates to maintain a predetermined gap between the substrates. In which case, for the above described embodiments, the reflective light enhancing pattern layer may not touch the first substrate, the light emitting element layer, or the black matrix. Further, it is contemplated that the reflective light enhancing pattern layer may not have completely reflective side surfaces. It is well within the scope and spirit of the present invention that the reflective light enhancing pattern layer comprises side surfaces that are partially reflective and partially non-reflective, in the direction across the gap between the first and second substrates, and/or in the lateral direction across the plane of the layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electro-luminescent display panel, comprising:
a first substrate comprising an array of light emitting elements corresponding to a plurality of pixels thereon; and
a second substrate comprising light transmissive regions; and
a reflective light enhancing pattern layer between the first substrate and the second substrate, wherein the reflective light enhancing pattern layer directs oblique light emitted from the light emitting elements to the light transmissive region.

2. The electro-luminescent display panel according to claim 1, wherein the reflective light enhancing pattern layer comprises reflective surfaces that are angled to reflect oblique light emitted from the light emitting elements towards the light transmissive regions in the second substrate.

3. The electro-luminescent display panel according to claim 1, wherein the reflective light enhancing pattern layer comprises reflective prisms or faceted reflective blocks.

4. The electro-luminescent display panel according to claim 1, wherein the light emitting elements comprises at least one of organic light emitting diodes or inorganic light emitting diodes.

5. The electro-luminescent display panel according to claim 1, wherein the light emitting elements are white light emitting units, and the light transmissive regions comprise a color filter (CF) layer therein.

6. The electro-luminescent display panel according to claim 1, wherein the light emitting elements are blue light emitting units, and the light transmissive regions comprise a color changing medium (CCM) therein.

7. The electro-luminescent display panel according to claim 1, further comprising a black matrix between the second substrate and the reflective light enhancing pattern layer.

8. The electro-luminescent display panel according to claim 1, the reflective light enhancing pattern layer is supported on at least one of the first and second substrates.

9. The electro-luminescent display panel according to claim 1, wherein the reflective light enhancing pattern layer is selected from the group consisting of a metal, a polymer material having reflective property and a combination thereof.

10. The electro-luminescent display panel according to claim 7, wherein the reflective light enhancing pattern layer comprises a first layer of reflective light enhancing pattern and a second layer of reflective light enhancing pattern aligned with the first layer.

11. The electro-luminescent display panel according to claim 7, wherein the black matrix is a separate layer from the reflective light enhancing pattern layer.

12. The electro-luminescent display panel according to claim 1, wherein the reflective light enhancing pattern layer extends between the first and second substrates to define a predetermined gap between the first and second substrates.

13. An electro-luminescent display panel, comprising:
a first substrate comprising an array of light emitting elements corresponding to a plurality of pixels thereon; and
a second substrate comprising light transmissive regions; and
a spacer array between the first substrate and the second substrate, defining a predetermined gap between the first and second substrates.

14. The electro-luminescent display panel according to claim 13, wherein the spacer array comprises reflective side surfaces directing oblique light emitted from the light emitting elements to the light transmissive region.

15. An electro-luminescent display panel comprising a first substrate including a plurality of light emitting elements having an anode layer, a cathode and an emitting layer thereon and a second substrate having a black matrix thereon, characterized in that:
an reflective light enhancing pattern layer between the first and the second substrates, wherein the reflective light enhancing pattern layer is located corresponding to the black matrix.

16. The electro-luminescent display panel according to claim 15, wherein the reflective light enhancing pattern layer is disposed on the first substrate between the light emitting elements.

17. The electro-luminescent display panel according to claim 15, wherein the top surface of the anode layer and the sidewall of the reflective light enhancing pattern layer has an plane included angle from 90°˜150°.

18. The electro-luminescent display panel according to claim 15, wherein the reflective light enhancing pattern layer comprises a polymer material having reflective property.

19. The electro-luminescent display panel according to claim 15, wherein the reflective light enhancing pattern layer is constituted of an insulating material layer and a reflective material coated on the insulating material layer.

20. An electronic device, comprising:
an electro-luminescent display panel according to claim 1; and
a driving device, electrically connected to the electro-luminescent display panel.
